(19) United States
(12) Patent Application Publication
(10) Pub. No.: US 2025/0259068 A1
(43) Pub. Date: Aug. 14, 2025

(54) TRAINING OBJECT DISCOVERY NEURAL NETWORKS AND FEATURE REPRESENTATION NEURAL NETWORKS USING SELF-SUPERVISED LEARNING

(71) Applicant: DeepMind Technologies Limited, London (GB)

(72) Inventors: Andrew Zisserman, London (GB); Daniel Zoran, London (GB); Andrew Coulter Jaegle, London (GB); Evan Gerard Shelhamer, London (GB); Joao Carreira, St. Albans (GB); Olivier Jean Henaff, London (GB); Relja Arandjelovic, Munich (DE); Skanda Kumar Koppula, London (GB)

(21) Appl. No.: 18/844,798

(22) PCT Filed: Mar. 16, 2022
(86) PCT No.: PCT/EP2022/056866

§ 371 Date: Sep. 6, 2024

Related U.S. Application Data
(60) Provisional application No. 63/317,464, filed on Mar. 7, 2022.

(51) Int. Cl. G06N 3/0895; G06N 3/045; G06N 3/0464

(52) U.S. Cl. CPC G06N 3/0895; G06N 3/045; G06N 3/0464

(57) ABSTRACT

A neural network system that is configured to learn a representation of data item, such as an image, audio, or text data item, through a self-supervised learning process. Implementations of the system couple two learning processes, an object discovery learning process and an object feature representation learning process. In implementations the object discovery learning process assists the object feature representation learning process in self-supervised learning of object feature representations, and the object feature representation learning process is used to improve the object discovery learning process.

### BACKGROUND

This specification relates to processing data using machine learning models.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes a system and method, implemented as computer programs on one or more computers in one or more locations, that is configured to learn a representation of data item, such as an image, audio, or text data item, through a self-supervised learning process. Implementations of the system couple two learning processes, an object discovery learning process and an object feature representation learning process. More specifically, in implementations the object discovery learning process assists the object feature representation learning process in self-supervised learning of object feature representations, and the object feature representation learning process is used to improve the object discovery learning process.

In a first aspect there is described a computer-implemented method of training a neural network. The method comprises, for a plurality of training data items, processing the training data item using an object discovery neural network to generate an object segmentation of the training data item. The object segmentation defines a segmentation of the training data item into a plurality of different objects represented by the training data item.

The method also involves processing a first transformed view of the training data item with a first feature representation neural network to generate a first representation of the first transformed view, processing a second transformed view of the training data item with a second feature representation neural network to generate a second representation of the second transformed view, combining the object segmentation and the first representation to generate a first object representation for each of the objects in the first transformed view, and combining the object segmentation and the second representation to generate a second object representation for each of the objects in the second transformed view.

The method further involves updating parameters of the first feature representation neural network by comparing a predicted object representation dependent upon the first object representation, and the second object representation. Parameters of the second feature representation neural network may be updated based on parameters of the first feature representation neural network. Parameters of the object discovery neural network may be updated based on parameters of the first feature representation neural network. The method may be performed iteratively, but the parameters of the object discovery neural network need not be updated for each training data item.

In some implementations the predicted object representation is derived from the first object representation e.g. by processing the first object representation using a prediction neural network; in some implementations the predicted object representation is the first object representation.

As described further later, the training data item may comprise, e.g., an audio data item, an image data item, a text data item, a graph data item, or a multimodal, e.g. audio-visual, data item. In implementations the objects are entities within audio, an image or video, text, or a graph, respectively represented by the audio data item, image data item, text data item, or graph data item. For a multimodal data item the objects may be entities defined by a combination of these types of data. In general a data item may comprise a plurality of data item elements e.g. a time sequence of waveform-representing elements for an audio data item, or pixels of an image data item.

The method may be used to obtain a trained neural network, e.g. a trained feature representation neural network or a trained object discovery neural network. The trained feature representation neural network may be used, for example, for transfer learning. The trained object discovery neural network may be used, for example, to process an input data item to generate an object segmentation of the input data item, where the object segmentation defines a segmentation of the input data item into a plurality of different objects represented by the input data item. After training not all of the trained neural network may be required. For example in some applications only part of the trained feature representation neural network is used for a task and an output portion of the trained neural network is discarded.

Also described is a system comprising one or more computers, and one or more storage devices communicatively coupled to the one or more computers. The storage devices store instructions that, when executed by the one or more computers, cause the one or more computers to perform the operations of the described method.

Further described are one or more non-transitory computer storage media storing instructions that when executed by one or more computers perform the operations of the described method.

The subject matter described in this specification can be implemented in particular embodiments so as to realize one or more of the following advantages.

Implementations of the described method and system facilitate a virtuous cycle of segmentation and representation quality: As the object discovery neural network is trained it helps the feature representation neural networks to train, and as the feature representation neural networks train they help the object discovery neural network to train. This can lead to large gains in accuracy and training efficiency, e.g. training can be accomplished faster or with fewer computing resources than hitherto, and more accurately.

Implementations of the method and system provide a self-supervised learning process that is able to train using unlabeled data, thus making much larger amounts of data available for training.

Implementations of the method and system do not rely on prior knowledge about the type of data processed and the types of task to be performed. Whilst using hand-crafted approaches can improve the performance of some techniques it comes at the cost of limiting the techniques in how much they can learn from the training data, and what training data they can be used on. In contrast implementations of the described method and system do not need to rely on exploiting prior knowledge about the data or task. This enables them to be applied to many different types of data, and potentially enables a higher ceiling on their ultimate performance. Some implementations of the method and system have demonstrated the ability to learn better quality representations than previous techniques, including hand-crafted techniques.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF DRAWINGS

FIG. 1 shows an example system for training object discovery and feature representation neural networks using a self-supervised learning process.

FIG. 2 shows a particular implementation of the system of FIG. 1.

FIG. 3 illustrates an example implementation of the system of FIG. 1 in operation.

FIG. 4 shows an example process for training the system of FIG. 1.

FIG. 5 shows an example process for using a trained feature representation neural network to perform a task.

FIG. 6 shows an example data processing neural network system including a trained feature representation neural network.

FIGS. 7a and 7b illustrate the performance of example implementations of the system.

In the Figures like reference numerals indicate like elements.

### DETAILED DESCRIPTION

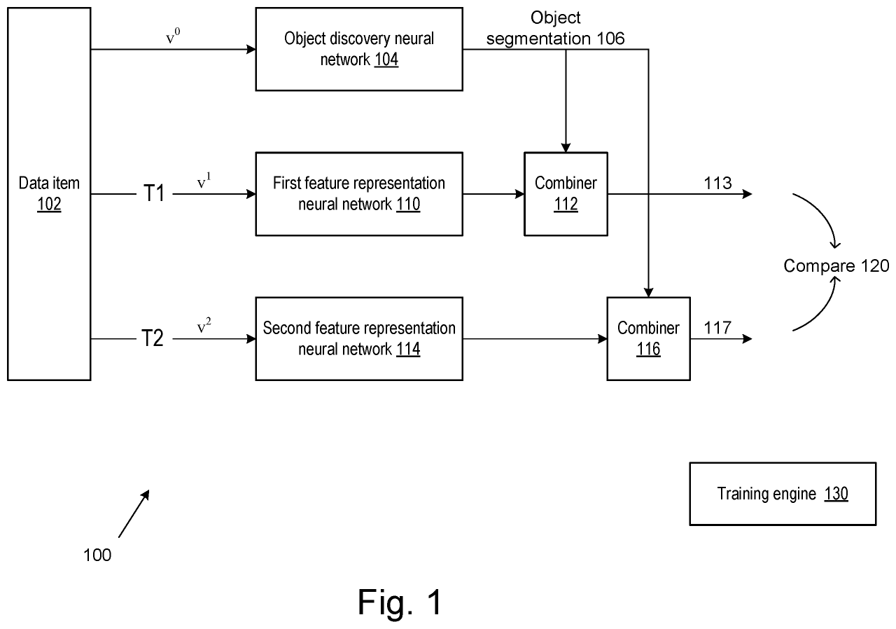

FIG. 1 shows a system 100 for training object discovery and feature representation neural networks using a self-supervised learning process. The system of FIG. 1 may be implemented as one or more computer programs on one or more computers in one or more locations.

The system 100 receives a data item 102, e.g. a training data item of a plurality of training data items that are used to train the object discovery and feature representation neural networks in the system. In general data items processed by the system, e.g. the training data items, may comprise any type of data item including, for example, an audio data item, an image data item (which, as used herein, includes a video data item), a text data item, a graph data item, or a multimodal data item. The system trains the object discovery and feature representation neural networks using self-supervision to represent the data items, and to discover, i.e. identify as present, objects represented by the data items. More details of the training data items and the objects they can represent are given later.

The data item 102, e.g. a training data item, is subjected to a first data item transformation T1 to obtain a first transformed view of the training data item, v¹. Similarly the data item 102 is subjected to a second data item transformation T2 to obtain a second transformed view of the training data item, v². Some examples of data item transformations that may be used are described later but may include, e.g., random crops of a data item, flipping (reversing) elements of a data item, or resizing (scaling) a data item.

The term “transformed view” refers to a transformed version of a training data item and is used to distinguish the training data item after it has undergone a transformation, e.g. a data augmentation transformation, from the original (untransformed) training data item. In general the first data item transformation is different from the second data item transformation, and the first and second transformed views are therefore different from one another.

The data item 102, e.g. a training data item, is processed by an object discovery neural network 104, in accordance with current values of a set of object discovery neural network parameters, to generate an object segmentation 106 of the data item. The object segmentation defines a segmentation of the data item into a plurality of different objects represented by the data item.

The object segmentation may be a soft or hard segmentation. For example a soft segmentation may define a respective score for each object of the plurality of different objects, where the score for an object characterizes a probability that an element of the data item is included in the object. A hard segmentation may specify, for each element of the data item, a corresponding object of the plurality of different objects. Generally, an object segmentation may be represented as an ordered collection of numerical values, e.g., an array of numerical values. The object segmentation 106 may be obtained in various ways; an approach based on grouping features is described later.

The first transformed view of a training data item, v¹, is processed by a first feature representation neural network 110, in accordance with accordance with current values of a set of first feature representation neural network parameters, to generate a first representation of the first transformed view, e.g. a first representation feature map. The first representation is combined, e.g. by a combiner 112, with the object segmentation 106 to generate a first object representation 113 for each of the objects in the first transformed view.

Similarly the second transformed view of the training data item, v², is processed by a second feature representation neural network 114, in accordance with accordance with current values of a set of second feature representation neural network parameters, to generate a second representation of the second transformed view, e.g. a second representation feature map. The second representation is combined, e.g. by a combiner 116, with the object segmentation 106 to generate a second object representation 117 for each of the objects in the second transformed view.

The object discovery neural network, the first feature representation neural network, and the second feature representation neural network, may have any appropriate neural network architecture including, e.g., one or more feedforward or convolutional neural network layers, or a transformer neural network subsystem, i.e. a neural network subsystem including one or more transformer blocks or self-attention layers, e.g. an architecture similar to a vision transformer. A transformer block typically includes an attention or self-attention neural network layer followed by a feedforward neural network. An attention, or self-attention, neural network layer is a neural network layer that includes an attention, or self-attention, mechanism that operates over an attention layer input to generate an attention layer output.

The system 100 is configured to compare 120 a predicted object representation dependent upon the first object representation, and the second object representation. The predicted object representation may be derived from the first object representation e.g. by processing the first object representation using a prediction neural network as described later; or the predicted object representation may be the first object representation.

A result of the comparison is used to update the parameters of the first feature representation neural network. Updating the parameters of the first feature representation neural network may comprise adjusting the values of the parameters e.g. by backpropagation of gradients of an objective function determined by comparing the predicted object representation and the second object representation. In general, as used herein, the parameters of a neural network include weights of the neural network.

The system is configured to update the parameters of the second feature representation neural network based on the parameters of the first feature representation neural network. Updating the parameters of the second feature representation neural network may comprise updating the parameters to approach or equal parameters of the first feature representation neural network, e.g. using a moving average of parameters of the first feature representation neural network or by copying parameters of the first feature representation neural network.

The system is also configured to update the parameters of the object discovery neural network based on the parameters of the first feature representation neural network. Updating parameters of the object discovery neural network based on the parameters of the first feature representation neural network may comprise updating parameters of the object discovery neural network, in particular parameters of an object discovery feature representation neural network part of the object discovery neural network (described further below), to approach or equal parameters of the first feature representation neural network. This may similarly involve updating based on a moving average of parameters of the first feature representation neural network, or by copying parameters of the first feature representation neural network. When the updating is by copying parameters the copying may be performed at intervals of a number, n, of epochs of updating the parameters of the first and second feature representation neural networks. This can reduce the computational cost without substantially affecting performance.

Where parameters & of a neural network are updated using a moving average of parameters, θ, of the first feature representation neural network, this may involve determining updated parameters according to ξ→(1−λ)ξ+λθ, where λ is a learning rate between zero and one.

In some other implementations the first feature representation neural network and the second feature representation neural network are the same neural network and have the same parameters. In such implementations updating parameters of the second feature representation neural network based on the parameters of the first feature representation neural network is performed inherently, by updating the parameters of the first feature representation neural network.

In implementations comparing the predicted object representation and the second object representation comprises determining a value of a contrastive objective function, and the parameters of first feature representation neural network are updated by backpropagating gradients of the contrastive objective function.

Such a contrastive objective function may have a term (a first term) dependent upon a first measure of similarity between the predicted object representation for one of the objects in the first transformed view and the second object representation for the same object in the second transformed view.

The contrastive objective function may have a term (a second term) dependent upon a second measure of similarity between the predicted object representation for one of the objects in the first transformed view and the second object representation for a different one of the objects, in the second transformed view of the training data item or in the second transformed view of another training data item. The first measure of similarity and the second measure of similarity may be the same measure of similarity.

Updating the parameters of the first feature representation neural network may comprise updating the parameters to maximize the first term and/or to minimize the second term e.g. to maximize the similarity of object representations of different views of the same object, and to minimize the similarity of object representations between different objects.

There are many different similarity measures that may be used. For example the measure of similarity may be based on a dot product similarity measure or on a cosine similarity measure. As one example the measure of similarity between object representations for an object k in views v¹ and v², sₖ^{1→2}, may be determined by

$${s}_{k}^{1 \to 2} = \frac{1}{α} \frac{〈 {q}^{k , 1} , {z}^{k , 2} 〉}{‖ {q}^{k , 1} ‖ ‖ {z}^{k , 2} ‖}$$

where [symbol] · [symbol] denotes an inner product (dot product); q^{k,1} denotes the predicted object (vector) representation, dependent upon the first object representation, for object k in view v¹; z^{k,2} denotes the second object (vector) representation, for object k in view v²; and α is an optional temperature, or scaling, hyperparameter where e.g. α=0.1.

A corresponding measure of similarity, sₖ^{1→n}, may also be determined between i) the predicted object representation for object k in view v¹, and ii) the second object representation, “n”, for a different object in view v² of the same training data item, or any object in view v² of another different training data item. Then the contrastive objective function may be defined as a combination of these measures of similarity, where sₖ^{1→n} may, for example, be determined for each of the objects that is present in both the first transformed view and the second transformed view.

As one particular example the contrastive objective function (loss function) for the predicted object representation for an individual object k in view v¹ may be determined as

$${l}_{k}^{1 \to 2} = - log \frac{exp ( {s}_{k}^{1 \to 2} )}{exp ( {s}_{k}^{1 \to 2} ) + {\sum }_{n} exp ( {s}_{k}^{1 \to n} )}$$

In implementations the value of the contrastive objective function is determined for each of the objects present in both the first transformed view and the second transformed view, and optionally also across different training data items. This may involve determining the first term of the contrastive objective function for each of these objects by computing the first measure of similarity between the predicted object representation for the object in the first transformed view and the second object representation for the same object in the second transformed view. This may also involve determining the second term of the contrastive objective function for each of these objects by computing the second measure of similarity between the predicted object representation for the object in the first transformed view and the second object representation for each different object in the second transformed view of the training data item.

As one example, the value of the contrastive objective function may be determined for each of the objects present in both the first transformed view and the second transformed view by summing lₖ^{1→2} over K objects and over views v¹ and v² to give a combined loss:

$$ℒ = \frac{1}{K} {\sum }_{k = 1}^{K} {l}_{k}^{1 \to 2} + {l}_{k}^{2 \to 1}$$

In implementations, operation of the system to train the object discovery and feature representation neural networks is controlled by a training engine 130. The training is performed iteratively, although not all the updating steps need to be performed for each training data item. For example, as previously described, the object discovery neural network may be updated at discrete intervals.

The iterative training may involve processing a first training data item using the object discovery neural network to generate the object segmentation of the first training data item, and generating the first object representation and the second object representation from the first training data item using the object segmentation of the first training data item.

Then the parameters of the first feature representation neural network may be updated by comparing the predicted object representation and the second object representation from the first training data item, and the parameters of the second feature representation neural network are updated, e.g. as previously described. Then the parameters of the object discovery neural network are updated based on the updated parameters of the first feature representation neural network.

After updating the parameters of the object discovery neural network, a second training data item is processed. This may involve processing the second training data item, using the object discovery neural network, to generate the object segmentation of the second training data item, and generating the first object representation and the second object representation from the second training data item using the object segmentation of the second training data item. Then the parameters of the first feature representation neural network are again updated by comparing the predicted object representation and the second object representation from the second training data item, and the parameters of the second feature representation neural network are updated, e.g. also as previously described.

The training process creates a virtuous circle in which the object discovery neural network uncovers structure within the training data items, allowing the self-supervised training of the first feature representation neural network to focus on learning invariant representations of objects. In turn, the resulting object representations are used to provide features for the object discovery process, which feeds back into the representation learning process. Thus better representations lead to better segmentations, and vice versa.

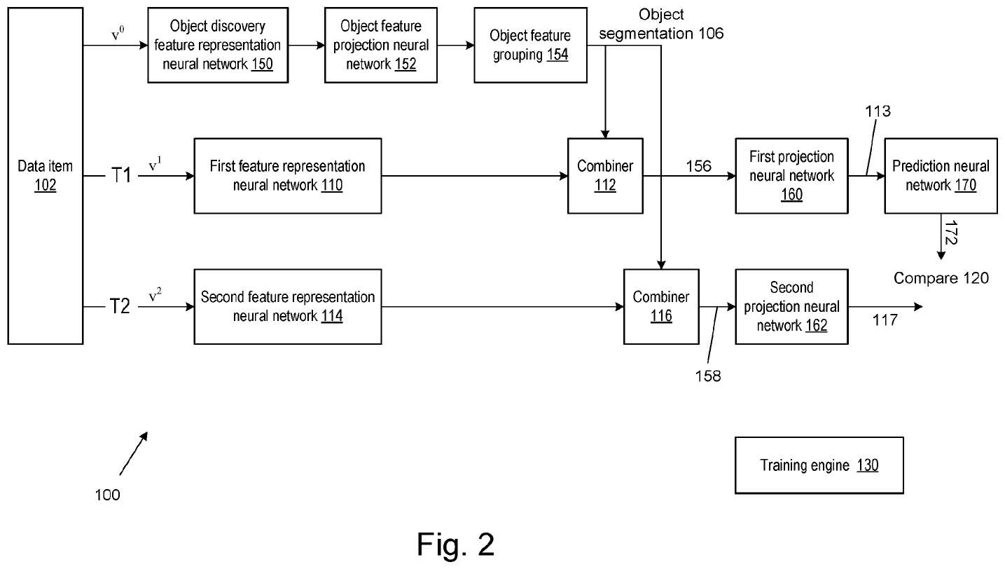

FIG. 2 shows an example of a particular implementation of the system 100 of FIG. 1. In the example of FIG. 2 the object discovery neural network 140 comprises an object discovery feature representation neural network 150 that is configured to process the data item 102, e.g. a training data item, in accordance with current values of a set of object discovery feature representation neural network parameters.

The object discovery neural network 140 may also comprise an object feature projection neural network 152 that is configured to process an output of the object discovery feature representation neural network 150, in accordance with current values of a set of object feature projection neural network parameters. The object discovery neural network parameters comprise the object discovery feature representation neural network parameters, and the parameters of the object feature projection neural network where present. The object feature projection neural network 152 may have any appropriate architecture e.g. a feedforward architecture, and as one particular example may comprise a multi-layer perceptron (MLP), such as a two-layer MLP.

The object discovery feature representation neural network 150, and the object feature projection neural network 152 where present, processes the training data item to generate a feature map of the training data item for generating the object segmentation 106.

The feature map may define, for elements of the training data item, a respective feature vector for the element. A feature map as described herein may be represented, e.g., as an array of numerical values having one or more dimensions running over the elements of the training data item and a “channel” dimension. For example the feature map may have one dimension when representing audio or text data; or two, three, or four dimensions when representing an image or video; or two or more dimensions when representing a multimodal combination. When representing a graph structure the feature map may have a graph structure; examples of graph structures are described later.

Like the first and second feature representation neural networks, the object discovery feature representation neural network may have any appropriate neural network architecture including, e.g., one or more feedforward or convolutional neural network layers or a transformer neural network subsystem.

As one particular example, the first, second, and object discovery feature representation neural networks may each comprise a neural network backbone coupled to a feature extractor neural network subsystem. For example, a feature representation neural network as described herein may comprise a ResNet backbone (He et al. “Deep residual learning for image recognition”, Proc. IEEE conference on computer vision and pattern recognition. pp. 770-778, 2016) or a Swin backbone (Liu et al. “Swin transformer: Hierarchical vision transformer using shifted windows”, Proc. IEEE/CVF International Conference on Computer Vision. pp. 10012-10022, 2021). The backbone may optionally be equipped with a Feature Pyramid Network feature extractor (Lin et al. “Feature Pyramid Networks for Object Detection”, Proc. IEEE conference on computer vision and pattern recognition. pp. 2117-2125, 2017) to extract features over a range of scales.

In implementations the object discovery feature representation neural network 150 processes a training data item to generate a feature map of the training data item. This is then used to generate the object segmentation 106 of the training data item. The system 100, e.g. training engine 130, is configured to update the parameters of the object discovery feature representation neural network to approach or equal values of the parameters of the first feature representation neural network, as previously described.

In general a data item 102, e.g. a training data item, comprises a plurality elements that representing the data item. For example in the case of an audio data item the elements may comprise waveform-representing elements of a waveform of the audio, e.g. amplitude or spectral values representing the waveform. In the case of an image data item the elements may comprise pixels of a still or moving image. Other examples are given later.

In the example implementation of FIG. 2 an object feature grouping subsystem 154 is configured to process the feature map of the training data item, from the object discovery feature representation neural network 150, to group similar feature vectors to determine a set of groups of feature vectors. Each group of feature vectors has a corresponding group of elements of the training data item, and there is a group for each of the different objects of the object segmentation 106. That is, in such implementations the groups of the elements of the training data item define the object segmentation 106. As examples, a group may comprise a group of waveform-representing elements for an audio data item, or a group of pixels for an image data item.

Any suitable technique may be used for grouping similar feature vectors. As one example, the grouping may comprise k-means clustering; as another the grouping may comprise expectation-maximization clustering. The number of groups, i.e. the number of objects in the object segmentation 106, K in k-means clustering, may be selected according to the type of data item and the content represented. The number of objects may be at least sufficient to represent a number of objects expected to be present (on average) in a data item, to avoid degrading the object discovery and, in implementations, the number of objects may be at least twice this value.

Determining the object segmentation 106 by grouping the feature vectors allows the object segmentation 106 to be performed without relying on prior knowledge about the structure or content of the data items. Whilst a hand-crafted object segmentation might perform better in a particular domain the described approach facilitates the system working more effectively across different types of data item, and with multimodal data items. It also allows the possibility that the system might learn to do better than a hand-crafted approach.

In some implementations each group of elements of the training data item defines a respective mask for the group of elements. Each mask may define elements for a respective one of the different objects. The elements for an object, i.e. the elements belonging to a group defining one of the objects, may then be obtained by applying the mask to the elements of a data item.

In such implementations the combiner 112 may generate the first object representation for each of the objects in the first transformed view by applying the respective mask for each of the objects in the first transformed view to the first representation of the first transformed view, e.g. to the first representation feature map. Similarly the combiner 116 may generate the second object representation for each of the objects in the second transformed view by applying the respective mask for each of the objects in the second transformed view to the second representation of the second transformed view, e.g. to the second representation feature map.

Where a data item transformation involves changing the relative or absolute position of an element of a training data item within the training data item, a corresponding transformation may also be applied to the mask for each of the objects in the transformed view. For example, a size of the mask for each of the objects in the transformed view may be adjusted to match the size of the transformed view.

The predicted object representation may be generated by processing the first object representation using a prediction neural network 170, in accordance with current values of parameters of the prediction neural network, to generate the predicted object representation 172; this can help improve training stability. In some other implementations the predicted object representation 172 is the first object representation 113. The prediction neural network may, in effect, implement a regression model. It may have any appropriate architecture e.g. a feedforward architecture; as one particular example it may comprise an MLP, e.g. a two-layer MLP. The parameters of the prediction neural network may be updated in the same way as those of the first feature representation neural network i.e. by comparing the predicted object representation and the second object representation and, e.g., backpropagating gradients of the contrastive objective function.

In the example of FIG. 2 generating the first and second object representations involves using respective first and second projection neural networks 160, 162 to process respective first and second intermediate object representations 156, 158. The first and second object representations may, but need not, be a reduced a dimensionality version of the first and second intermediate object representations. The first and second projection neural networks may have any appropriate architecture e.g. a feedforward architecture. As one particular example they may each comprise an MLP, such as a two-layer MLP.

Combining the object segmentation and the first representation to generate the first object representation for each of the objects in the first transformed view may comprise combining the object segmentation and the first representation to generate the first intermediate object representation 156 for each of the objects in the first transformed view. The first intermediate object representation for each of the objects is then processed using the first projection neural network, and in accordance with parameters of the first projection neural network, to generate the first object representation 113 for each of the objects in the first transformed view. Similarly, combining the object segmentation and the second representation to generate the second object representation for each of the objects in the second transformed view may comprise combining the object segmentation and the second representation to generate the second intermediate object representation 158 for each of the objects in the second transformed view. Then the second intermediate object representation for each of the objects is processed using the second projection neural network, and in accordance with parameters of the second projection neural network, to generate the second object representation 117 for each of the objects in the second transformed view.

The parameters of the first projection neural network may be updated by comparing the predicted object representation and the second object representation, e.g. as previously described. Similarly the parameters of the second projection neural network may be updated based on the parameters of the first feature representation neural network, again as previously described.

In general the first feature representation neural network and the second feature representation neural network, and the first and second projection neural networks where present, are different neural networks. However the first feature representation neural network and the second feature representation neural network may have the same architecture (and relevant hyperparameters) and different parameters, e.g. different weights. Similarly, in implementations the object discovery feature representation neural network, and the object feature projection neural network 152 where present, has the same architecture (and relevant hyperparameters) as the first feature representation neural network and different parameters, e.g. different weights. This facilitates updating the parameters of the second feature representation neural network based on a moving average or copy of parameters of the first feature representation neural network. Where the first, second, and object feature projection neural networks are present these may also have the same architecture (and relevant hyperparameters) as one another but different parameters, i.e. different weights.

In some implementations the first feature representation neural network and the second feature representation neural network are the same neural network and there is only one updating step-that is updating parameters of the second feature representation neural network is inherently performed by updating the parameters of the first feature representation neural network. In these implementations the first and second projection neural networks, where present, are also the same neural network, so that updating the parameters of the second projection neural network is similarly inherently performed by updating the parameters of the first projection neural network.

To aid in understanding operation of the system a particular example implementation is now described. In this example a view, v⁰, of data item 102 is determined and processed. This may be the entire data item, or just part of the data item. Where the view v⁰ is just part of the data item it should span, i.e. encompass, the transformed views v¹ and v² that are generated from the data item.

The object discovery feature representation neural network 150, f_{τ}(·), generates a feature map comprising respective feature vectors h⁰=f_{τ}(v⁰), where h⁰ defines a first feature map with, e.g., D channels, and τ denotes the parameters of the object discovery neural network. The first feature map is further processed by the object feature projection neural network 152, g_{τ}(·), to generate a second feature map z⁰=g_{τ}(h⁰) that is a projection of the first feature map with, e.g., d channels, where optionally d<D. The second feature map z⁰ of the data item is used for generating the object segmentation 106, e.g. by applying k-means clustering to z⁰, to generate K non-overlapping binary masks, m^{k,0}∈{0,1} where k=1 . . . K, that together form the object segmentation 106.

The data item 102 is subjected to the first and second data item transformations T1 and T2 to obtain the first and second transformed views, v¹ and v². The transformations may generally include identity preserving transformations i.e. transformations in which the objects in the training data item are still recognizable in the transformed views. Each transformation may comprise a composition, i.e. combination, of transformations. For example each transformation may be defined by a distribution that defines a probability of each of a set of possible transformations, and the particular transformation applied may be determined by sampling from this distribution. The distributions for the first and second data item transformations T1 and T2 may be different. In some implementations each transformation includes a random crop, i.e. this may have probability 1.0 in the distributions. For computational convenience the first and second transformed views, v¹ and v², may be rescaled so that they are a predetermined size, e.g. they may be rescaled so that they have half the number of elements of the view v⁰ in each dimension.

The system obtains two sets of transformed binary masks, m^{k,1} and m^{k,2}, that are aligned with the underlying image content by transforming each mask m^{k,0} (insofar as necessary). For example this may involve cropping, flipping, or resizing each mask m^{k,0}. Despite significant differences in apparent content the two sets of transformed binary masks contain substantially the same underlying semantic content (up to differences in cropping), and this facilitates the self-supervised learning.

The first feature representation neural network 110, f_{θ}(·), generates a feature map comprising respective feature vectors h¹=f_{θ}(v¹), where h¹ defines the first representation feature map with, e.g., D channels. Here θ denotes the parameters of the first feature representation neural network and also the parameters of the first projection neural network 160. Similarly the second feature representation neural network 114, f_{ξ}(·), generates a feature map comprising respective feature vectors h²=f_{ξ}(v²), where h² defines the second representation feature map with, e.g., D channels. Here ξ denotes the parameters of the second feature representation neural network and also the parameters of the second projection neural network 162.

The system generates the first intermediate object representation 156 for each of the objects in the first transformed view by combining the object segmentation m^{k,0}∈{0,1}, more particularly the transformed mask for the first transformed view m^{k,1}, and the first representation feature map h¹. More specifically, for each mask k the features in the first representation feature map selected by the mask are pooled, e.g. averaged. For example, for a two-dimensional data item a mask-pooled hidden vector for a mask k, h^{k,1}, may be determined as:

$${h}^{k , 1} = \frac{1}{{\sum }_{i , j} {m}^{k , 1} [ i , j ]} {\sum }_{i , j} {m}^{k , 1} [ i , j ] {h}^{1} [ i , j ]$$

where i, j run over the elements of the (in this example) two-dimensional data item. For example in the case of a two-dimensional image i and j may run over pixels of the image in the image width and image height dimensions. The determination of h^{k,1} may be adapted to a one-dimensional data item by removing one of the indices i, j; or to a data item with more than two dimensions by adding one or more indices.

Similarly the system generates the second intermediate object representation 158 for each of the objects in the second transformed view by combining the transformed mask for the second transformed view m^{k,2}, and the second representation feature map h², e.g. as:

$${h}^{k , 2} = \frac{1}{{\sum }_{i , j} {m}^{k , 2} [ i , j ]} {\sum }_{i , j} {m}^{k , 2} [ i , j ] {h}^{2} [ i , j ]$$

In this particular described example the mask-pooled hidden vector for each mask k, h^{k,1}, provides the first intermediate object representation 156. This is processed by the first projection neural network 160, g_{θ}(·), to generate the first object representation 113, z^{k,1}=g_{θ}(h^{k,1}) with, e.g., d channels. Similarly the mask-pooled hidden vector for each mask k, h^{k,2}, provides the second intermediate object representation 156. This is processed by the second projection neural network 160, g_{ξ}(·), to generate the first object representation 113, z^{k,2}=g_{ξ}(h^{k,2}) with, e.g., d channels.

It is desirable that the object representations for an object should be approximately invariant across different views of the same object. In particular it is desirable that the mask-pooled hidden vector in one view is predictive of the mask-pooled hidden vector in the other view (which has the same semantic content). Including the projection neural networks helps the system learn to achieve this.

In principle the parameters ξ could be the same as the parameters θ and one of the first and second the first object representations could be regressed onto the other. In this described example, however, the predicted object representation is generated by the prediction neural network 170, q_{θ}(·), as q^{k,1}=q_{θ}(z^{k,1}). Here the parameters of the prediction neural network are also represented by ν.

The vectors q^{k,1} and z^{k,2} may be used when comparing the predicted object representation and the second object representation, e.g. in determining the measures of similarity sₖ^{1→2} and sₖ^{1→n} as previously described.

The neural networks having the parameters θ may collectively be referred to as an online neural network. Thus the online neural network may comprise the first feature representation neural network 110 and, where present, the first projection neural network 160 and the prediction neural network 170. The neural networks having the parameters ξ may collectively be referred to as a target neural network. Thus the target neural network may comprise the second feature representation neural network 114 and, where present, the second projection neural network 162.

In implementations the online neural network is trained by comparing the predicted object representation and the second object representation, e.g. by determining a value of the contrastive objective function; and parameters of the target neural network are updated based on the parameters of the online neural network. The parameters of the object discovery neural network are also updated based on the parameters of the online neural network.

More specifically, in one example implementation the parameters θ are updated according to:

θ←optimizer (∇_{θ} [symbol] ; λ_{θ})

where ∇_{θ} denotes gradients of the combined loss [symbol] with respect to parameters θ; optimizer(·) denotes an optimizer, e.g. LARS (Layer-wise Adaptive Rate Scaling, You et al., “Large Batch Training of Convolutional Networks”, arXiv:1708.03888v3); and λ_{θ} denotes a learning rate for the optimizer. The parameters ξ may be determined from the corresponding parameters θ of the online neural network, e.g. according to:

$$ξ ← ( 1 - {λ}_{ξ} ) ξ + {λ}_{ξ} θ$$

where λ_{ξ} denotes a learning rate hyperparameter for the target neural network. Similarly the parameters τ of the object discovery neural network may be determined from the corresponding parameters θ of the online neural network, e.g. according to:

$$τ ← ( 1 - {λ}_{τ} ) τ + {λ}_{τ} θ$$

where λ_{τ} denotes a learning rate hyperparameter for the object discovery neural network. Merely as an example the learning rate hyperparameters λ_{ξ}, λ_{τ}, may be of order 10⁻² or 10⁻³. In an example where the parameters of the object discovery neural network are updated at discrete intervals λ_{τ}=1 every n epochs (where e.g. n=10 or n=100) and λ_{τ}=0 otherwise.

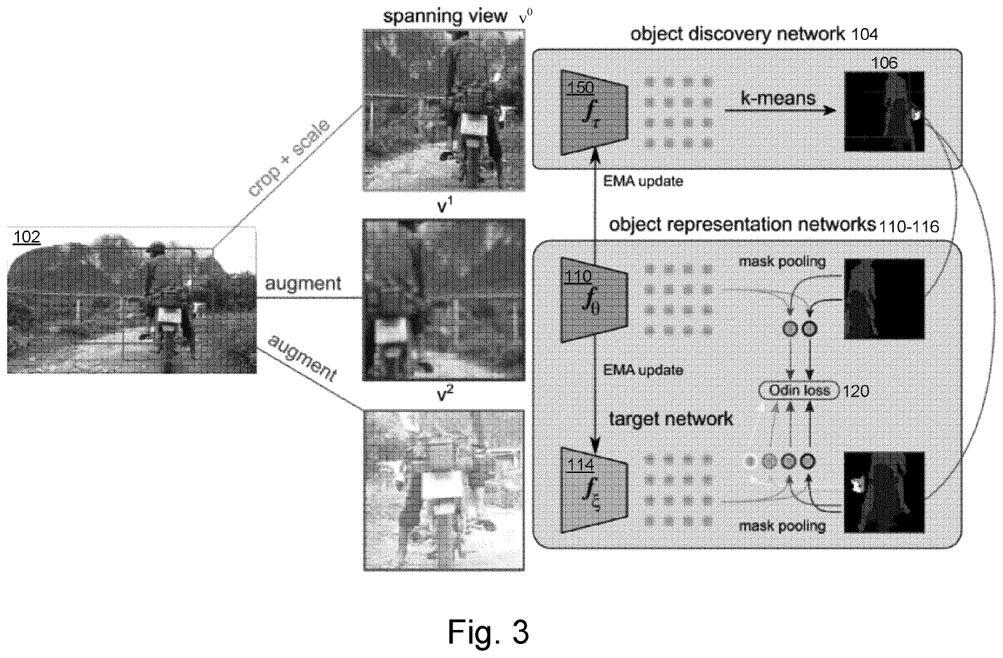

FIG. 3 schematically illustrates a particular example implementation of the system 100 in operation, in a case where the data items comprise static 2D images. In this example a view v⁰ of image data item 102 is processed by the object discovery neural network 104, using k-means clustering on a feature map of v⁰, to generate the object segmentation 106, here comprising a set of masks. The object segmentation 106 is mapped into two transformed views of the same data item, v¹ and V² (as illustrated, respectively cropped and blurred, and cropped and color-dropped), and the masks are aligned across the views and thus with the underlying image. The object representation neural networks, i.e. the first and second feature representation neural networks 110, 114, take the views v¹ and V² as respective inputs. The feature maps that they generate are combined with the respective aligned masks to generate pooled features for each mask and view, by pooling the features within each mask i.e. for each supposed object. The first and second feature representation neural networks 110, 114 are trained using a self-supervised objective based on the features pooled within each mask. The object discovery network 104 is regularly updated using an exponential moving average of one of the object representation neural networks, i.e. the first object feature representation neural network 110.

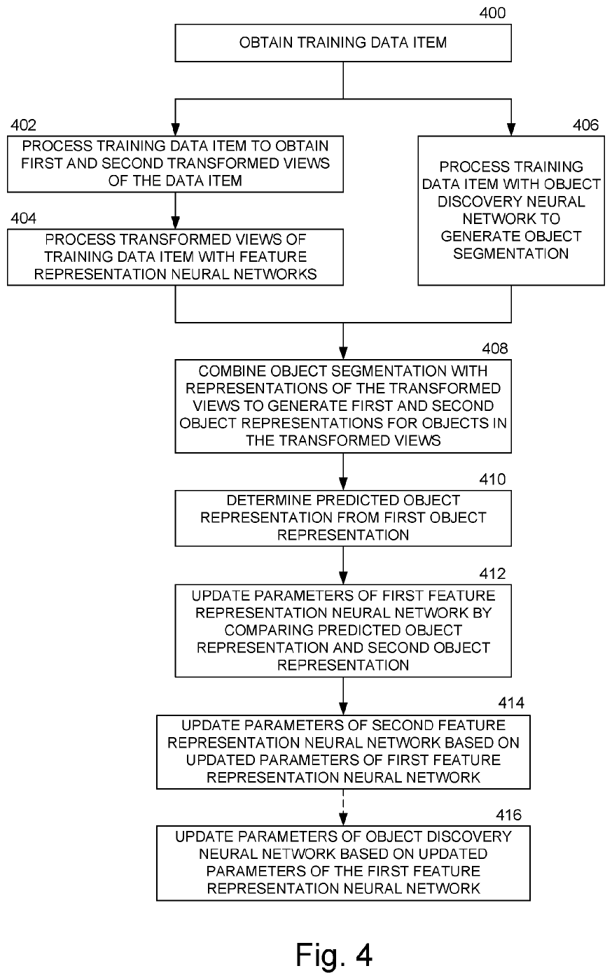

FIG. 4 shows a flow diagram of an example process for training the system of FIG. 1. The process of FIG. 4 may be implemented as one or more computer programs on one or more computers in one or more locations.

The parameters of the object discovery neural network 104 and of the first and second feature representation neural networks 110, 114 may be initialized to random values. At step 400 a training data item 102 is obtained. This is then processed to obtain the first and second transformed views, v¹ and v², of the data item (step 402), and these views are processed by the respective first and second feature representation neural networks 110, 114 to obtain first and second representations of the transformed views (step 404).

The training data item 102 is also processed by the object discovery neural network 104 to obtain the object segmentation 106 (step 406), and the object segmentation 106 is combined with the first and second representations of the transformed views to obtain respective first and second object representations for the objects in the transformed views (step 408).

The predicted object representation is determined form the first object representation (step 410), and the parameters of the first feature representation neural network are updated by comparing the predicted object representation dependent and the second object representation (step 412). In implementations this involves determining a value of the contrastive objective function, dependent upon the predicted object representation and the second object representation, by comparing the predicted object representation and the second object representation and backpropagating gradients of the contrastive objective function. The parameters of the second feature representation neural network are updated based on the updated features of the first feature representation neural network (step 414).

Steps 400-414 of the process are performed for each of the training data items. For at least some of the training data items 102, but not necessarily for each training data item, the parameters of the object discovery neural network are also updated based on the updated features of the first feature representation neural network (step 416).

The above described system and method may be used to obtain a trained neural network, in particular a trained first or second feature representation neural network 110, 114, or object discovery neural network 104, for a subsequent task. The subsequent task may be a task performed by another system to which the trained neural network is transferred for performing, or for learning to perform, the task.

After training not all of a trained neural network may be required. For example only an initial or front-end part of the trained first feature representation neural network 110 (or, equivalently, of the trained second feature representation neural network 114) may be needed for the task. Here the front-end part of the neural network is the part that processes the input to the neural network, and may include one or more subsequent layers of the neural network, but does not include one or more output layers of the neural network as trained by the system 100.

Where, as previously described, the trained feature representation neural networks 110, 114 include an output portion, e.g. a feature extractor, to provide the feature map, this output portion may be discarded after training and just the remainder of the trained feature representation neural network used to perform the task. For example where a feature representation neural network comprises a neural network backbone coupled to a feature extractor neural network subsystem, the feature extractor neural network subsystem may be discarded and just the neural network backbone used for a subsequent task.

The trained object discovery neural network 104 may be used in its entirety to perform an object segmentation task, and may then provide the object segmentation 106 as an output. In implementations where the object discovery neural network 104 comprises the object discovery feature representation neural network 150, the object feature projection neural network 152, and the object feature grouping subsystem 154, these may all be used to process a data item to the object segmentation 106 as an output. Alternatively only part of the trained object discovery neural network 104 may be used to perform a task, e.g. the trained object discovery feature representation neural network 150.

In general the trained neural network, or part thereof, that is provided by the system and that may be used for a subsequent task, may be part of the object discovery neural network, part of the first feature representation neural network, or part of the second feature representation neural network. When used to perform a subsequent task the parameters of the trained neural network may be frozen, or subject to further training on the task.

The task (i.e. the subsequent task) that the trained neural network, or part thereof, is used to perform may generally correspond to a type of the training data item. For example where the training data item comprises an audio data item, an image data item, a multimodal data item, a text data item, or a graph data item, the trained neural network, or part thereof, may be used, correspondingly, to process input data comprising audio data, image data, multimodal data, text data, or graph data respectively to perform an audio signal processing task, an image processing task, a multimodal processing task, a text processing task, or a graph processing task.

As one example the training data item, and input data, may comprise audio data representing values of a digitized audio waveform, e.g. a time sequence of waveform-representing elements. Such a representation may comprise, e.g., samples representing digitized amplitude values of the waveform or a time-frequency domain representation of the waveform such as a STFT (Short-Term Fourier Transform) or MFCC (Mel-Frequency Cepstral Coefficient) representation. The audio waveform may comprise e.g. a speech waveform or a waveform of a sound, e.g. a captured sound. As some examples of transformations that may be used, transformed views of the training data item may be obtained by transformations including: time or pitch warps; random crops in the time or frequency domain, e.g. selections of portions of the audio data item with random start and end times or with randomly selected upper and lower frequencies; modifications to the amplitude of a data item e.g. by randomly increasing or diminishing the amplitude of the audio; or modifications to the frequency characteristics of the audio e.g. by randomly filtering the audio. Objects in the audio may comprise e.g. speech elements such as words, syllables, or phonemes; or events or other distinguishable audio objects in the sound.

The audio signal processing task may comprise, e.g.: processing audio data representing speech to provide output data that detects words or phonemes in the speech or categorizes words or phonemes in the speech into one or more of a plurality of categories; or processing audio data representing a sound to provide output data, e.g. likelihood data, that detects presence of a particular sound or audio object or event in the sound e.g. in a hotword detection or identification task; or processing audio data representing a sound to provide output data that categorizes a content of the sound into one or more of a plurality of categories (i.e. classifying a sound). In some further examples the audio signal processing task may comprise, e.g.: an identification or classification task such as a speech or sound recognition task, e.g. a hotword detection or identification task, a speaker or natural language classification task, or an audio tagging task, in which case the output data may comprise a category score or tag for the audio or for a segment of the audio; or a similarity determination task e.g. an audio copy detection or search task, in which case the output data may comprise a similarity score.

In some implementations the training data item, and input data, may comprise sensor data representing values of a digitized sensor waveform i.e. a sensor other than an audio sensor may be used to obtain the digitized waveform. The digitized sensor waveform may be treated similarly to a digitized audio waveform, and the transformed views may correspond with those described above. The sensor data may generated by sensors configured to monitor the real-world state, condition or environment of a physical system, e.g. of a mechanical or electronic physical system or machine, e.g. sensing force, pressure, movement, temperature, or vibration. The objects may comprise events or other distinguishable objects in the sensor data, or conditions of the physical system. The signal processing task may be to process the input data to provide output data that identifies the presence of one or more of the events, objects, conditions or environments.

As another example the training data item, and input data, may comprise image data representing a still or moving image, i.e. an image or video, e.g. an image or video that has been captured using a camera. Elements of the image data may comprise monochrome or color pixels of the image or video. As defined herein an “image” includes a point cloud e.g. from a LIDAR system, and a “pixel” includes a point of the point cloud. Similarly “video” includes a time sequence of point clouds. Objects in the image or video may comprise objects, e.g. physical objects, represented by the image or video.

The transformed views of the training data item may generally include e.g. random crops or distortion of the training data item. As some particular examples, for image data transformed views of the training data item may be obtained by transformations including: random cropping of the image or video, flipping the image or video, color jittering, color dropping, blurring e.g. Gaussian blurring, and solarization. Random cropping may comprise selecting a random patch of the image; optionally the patch may then be re-sized. Flipping the image or video may involve applying a horizontal or vertical flip to the image. Color jittering may comprise changing one or more of the brightness, contrast, saturation and hue of some or all pixels of the image or video, e.g. by a random offset. Color dropping may comprise converting the image or video to a reduced color or greyscale version. Blurring such as Gaussian blurring may comprise applying a blurring kernel e.g. a Gaussian blurring kernel to the image or video; other types of kernel may be used for other types of filtering. Solarization may comprise applying a solarizing color transform to the image or video; other color transforms may be used. Other transforms are possible such as rotation, or cutting out part of the image or video (e.g. by setting pixels of a random patch to a uniform value). The transformation may include an adversarial perturbation e.g. selected to increase a likelihood that an erroneous object representation is generated.

The image processing task may comprise, e.g.: processing the image data to provide output data that identifies the location of one or more specified or unspecified objects in the image or video, e.g. output data that defines one or more object bounding shapes or boxes; or processing the image data to provide output data that segments pixels of the image or video into regions that represent one or more objects in the image or video signal; or processing the image data to provide output data that categorizes a content of the image or video into one or more of a plurality of categories; or processing the image data to provide output data that predicts depth values for pixels of the image or video. A task that segments the pixels may be e.g. a semantic segmentation task that associates each pixel with a category representing a class of objects, or an instance segmentation task that associates each pixel with a category representing an instance of an object, i.e. to distinguish between different instances of the same category of object.

Where the image data comprises pixels of a video the image processing task may comprise, e.g.: processing the image data to provide output data that identifies the location of one or more actions represented in the video; or processing the image data to provide output data that categorizes one or more actions, e.g. gestures, represented in the video into one or more of a plurality of categories.

In general the image processing task may include any sort of image processing or vision task such as an image classification or scene recognition task, an image segmentation task e.g. a semantic or instance segmentation task, an object localization or detection task, or a depth estimation task. When performing such a task the input data may be derived from pixels of the image. For an image classification or scene recognition task the output may comprise a classification output providing a score for each of a plurality of image or scene categories e.g. representing an estimated likelihood that the image data or an object represented in the image data, or that an action within image data representing a video, belongs to a category of a set of categories. For an image segmentation task the output may comprise, for each pixel, an assigned segmentation category or a probability that the pixel belongs to a segmentation category, e.g. to an object or action represented in the image or video. For an object localization or detection task the output may comprise data defining coordinates of a bounding box or region for one or more objects represented in the image. Such a bounding box or region may be defined in two, three or more dimensions (time counting as a dimension). For a depth estimation task the output may comprise, for each pixel, an estimated depth value. The output may define a continuous value or it may define a probability distribution over discrete depth value buckets, such that the output pixels define a (spatial 3D) depth map for the image. Such tasks may also contribute to higher level tasks, e.g. to object tracking across video frames; or to gesture recognition i.e. recognition of gestures that are performed by entities depicted in a video. As another example, the image processing task may include an image keypoint detection task in which the output comprises the coordinates of one or more image keypoints, such as landmarks of an object represented in the image, e.g. a human pose estimation task in which the keypoints may define the positions of body joints. A further example is an image similarity determination task, in which the output may comprise a value representing a similarity between two images, e.g. as part of an image search task.

As another example the training data item, and input data, may comprise text data; elements of the text data may comprise e.g. sentences, words, or parts of words e.g. wordpieces. The transformed views of the training data item may generally include identity preserving transforms i.e. those in which the objects in the training data item, e.g. semantic concepts, are still recognizable. As some particular examples, transformed views of the training data item may be obtained by transformations including crops of the data item or distortions of the data item such as grammar or spelling distortions. The text processing task may comprise, e.g.: a part-of-speech tagging task, in which case the output data may comprise e.g. a category score or tag for the text or for a segment of the text; or a dependency parsing task, in which case the output data may comprise data representing a dependency parse of the text; or a text segmentation task, in which case the output data may comprise data that associates elements of the text with one or more of a plurality of categories for the text. Other example tasks include an identification or classification task, or a similarity determination task, e.g. to generate a category score, a similarity score, or a tag as described above; or a machine translation task.

As another example the training data item, and input data, may comprise multimodal data. In general such multimodal data is a combination of two or more different types of data, where the different types of data represent the same or overlapping objects using the different modalities (types). As one example the multimodal data may comprise audio-visual data, comprising a combination of pixels of an image or of video and audio data representing values of a digitized audio waveform. As another example the multimodal data may comprise a combination of i) text data representing text in a natural language and ii) pixels of an image or of video or audio data representing values of an audio waveform. Elements of the multimodal data may correspond to elements of the data types making up the combination; and transformed views of the training data items may be generated as described herein for the data types making up the combination. Optionally, but not necessarily, when processing multimodal data the data may be mapped into a common embedding space.

In general the multimodal processing task may correspond to any of the tasks previously described for any of the types of data making up the multimodal combination. For example, an accuracy of the previously described tasks may be increased when the task is applied to multimodal data combining the data for which the task has been previously described and another type of data. For example detection or classification of an object or event may be improved when data of multiple different types (modalities) is processed.

As one particular example, where the multimodal data comprises audio-visual data the multimodal processing task may comprise: processing the combination, i.e. the image/video and audio, to provide output data that detects presence of a particular multimodal object or event in the combination (e.g. to identify a phoneme or viseme when lip reading); or processing the combination to provide output data that categorizes the combination into one or more of a plurality of categories, e.g. by defining a score for each category of a plurality of possible categories for the combination. As another particular example, where the multimodal data comprises a combination of text data and image or video or audio data the multimodal processing task may comprise processing the combination to provide output data that defines whether the image or video or audio waveform is described by the text, e.g. by a particular caption, e.g. by defining a score for the text or caption.

As another example the training data item, and input data, may comprise graph data; in such implementations the neural networks described herein may comprise graph neural networks. In general the graph data may define a graph structure having a set of nodes with associated node feature vectors connected by edges which may have associated edge feature vectors. A graph may, but need not be, defined by an adjacency matrix e.g. where Nis the number of nodes, an N×N matrix defining which nodes are connected by edges. Elements of the graph data may comprise e.g. nodes or edges of a graph represented by the graph data.

A graph may represent a real-world physical system; merely as some examples, a mechanical structure in which bodies are connected by joints, or a structure of a molecule such as a drug molecule. The objects may comprise e.g. physical bodies or parts of a molecule e.g. chemical moieties. Transformed views of the training data item may be obtained by transformations such as node feature masking or edge masking. For example each node may have one or more node features masked, e.g. the same feature may be masked for each node; or edge features or edges may be masked, e.g. using a binary mask to remove edges; or a structure of the graph may be modified e.g. by modifying the adjacency matrix where present. A mask used for generating such a transformed view may be generated randomly. The graph processing task may comprise e.g.: characterizing a physical entity represented by the graph to provide output data that defines a predicted stability of the physical structure or molecule, or the binding affinity of a molecule represented by the graph with another molecule e.g. to identify a drug candidate (which may then be evaluated by synthesizing the molecule and e.g. testing the molecule in vitro or in vivo). The predicted stability of the physical structure may be used e.g. to design or evaluate a structure; the result may then be used to construct a structure to the design. As another example the graph may be a scene graph that represents a scene; the scene graph may have been generated from a captured real-world image. The graph processing task may then comprise generating output data that identifies or classifies the scene or one or more objects within the scene e.g. to facilitate object/scene editing or information extraction for scene interpretation.

In general a feature representation neural network trained as described above may be used to process input data, e.g. an input data item, to generate a representation of the input data, e.g. of the input data item, and to output the representation for further processing. That is, the features learned by the trained representation neural network are useful in a more general context.

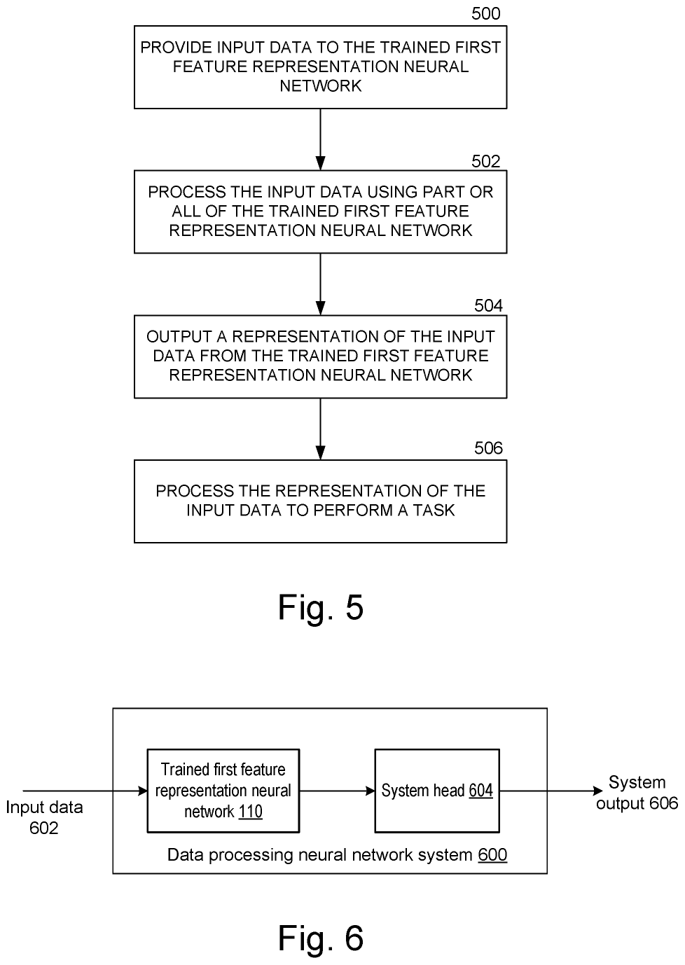

FIG. 5 shows an example process for using the trained first feature representation neural network 110 to process input data to perform a task as described above. The process may be implemented as one or more computer programs on one or more computers in one or more locations.

At step 500 input data, e.g. as described above, is provided to the trained first feature representation neural network 110. The input data item is processed using part or all of the trained first feature representation neural network (step 502), to output a representation of the input data item (step 504). This is then processed further to perform a task (step 506), e.g. an audio signal processing task, an image processing task, a multimodal processing task, a text processing task, or a graph processing task as previously described.

FIG. 6 shows an example data processing neural network system 600 including a trained first feature representation neural network 110 (or part thereof). The system 600 includes an optional system head neural network 602, adapted to a data processing task to be performed. The system 600 is configured to receive input data 602, and to process the input data using the trained first feature representation neural network 110, or part thereof (e.g. a backbone part as previously described), and optionally using the system head neural network 602, to provide a system output 606 comprising output data e.g. as previously described. In a variant of the data processing neural network system 600 the trained first feature representation neural network 110 is replaced by the trained object discovery neural network 104.

Implementations of the system 100 provide a trained feature representation neural network that may be used as the feature representation neural network in any conventional architecture. That is, implementations of the system allow a feature representation neural network to be trained using a self-supervised technique, i.e. without requiring labelled training data. Implementations of the system can perform such self-supervised training faster and are more efficiently than some conventional approaches, i.e. they can use fewer computing resources for the same or better accuracy.

Once the feature representation neural network has been trained it may be included in place of a feature representation neural network in a conventional neural network system architecture to perform any of the previously described tasks. The system head neural network 604 may use any conventional neural network adapted to the task to be performed. The data processing neural network system 600 may be trained to perform the data processing task. When included in the data processing neural network system 600 the parameters of the trained feature representation neural network may be frozen, or they may be further trained on the task in conjunction with other parameters of the system 600.

An object discovery neural network trained as described above may be used to process an input data item to generate an object segmentation of the input data item, where the object segmentation defines a segmentation of the input data item into a plurality of different objects represented by the input data item.

Such an object segmentation is intrinsically useful. Merely as one example, the trained object discovery neural network may be used to process an input image to determine an object segmentation for the image that associates each pixel of the image with an object of one or more objects that may be represented in the image. For example a medical image may be processed to label pixels of the medical image in accordance with which region of a human or animal body they show, or to identify pixels of the medical image in which a particular medical condition is present.

The object segmentation from the trained object discovery neural network, or the feature representation from the trained feature representation neural network, may be used to provide an input to a control system of a mechanical agent, such as a robot or vehicle operating in a real-world environment. The control system may provide an output that controls the operation of the robot or vehicle to perform a task such as manipulating an object in the environment or moving in the environment. The detected objects may be, e.g., objects for the robot to manipulate, or obstacles or paths upon which the mechanical agent can move, and may be used by the control system e.g. to make decisions on how to accomplish a task performed by the robot, or for controlling the direction or speed of movement of the agent.

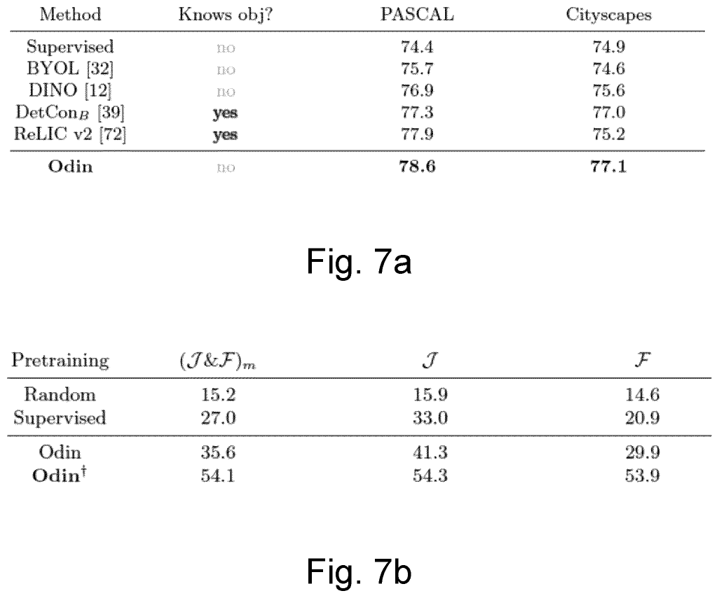

FIGS. 7a and 7b illustrate the performance of example implementations of the system 100. FIG. 7a relates to use of the trained first feature representation neural network 110 in a system 600 that to trained to perform semantic segmentation, i.e. using transfer learning. The semantic segmentation is applied to the PASCAL and Cityscapes image datasets (Everingham et al. “The PASCAL visual object classes challenge: A retrospective”, International journal of computer vision 111(1), 98-136, 2015; Cordts et al. “The Cityscapes dataset for semantic urban scene understanding”, Proc. IEEE conference on computer vision and pattern recognition, pp. 3213-3223, 2016). The table provides figures of merit that compare the relative performance of pre-training followed by transfer learning using: supervised pre-training; BYOL (Grill et al., arXiv:2006.07733); DINO (Caron et al., arXiv:2104.14294); DetConB (Hénaff et al., arXiv:2103.10957); ReLIC V2 (Tomasev et al. arXiv:2201.05119); and the described system 100, labelled as “Odin”. The system described herein is the best-performing technique. (The “knows obj?” column refers to whether or not the system uses a hand-crafted algorithm).

FIG. 7b relates to use of the trained first feature representation neural network 110 in a system 600 that to trained to perform video object segmentation, i.e. using transfer learning, on the DAVIS-17 dataset (Perazzi et al. “A benchmark dataset and evaluation methodology for video object segmentation”, Proc. IEEE conference on computer vision and pattern recognition, pp. 724-732, 2016). The table gives image region ( [symbol] ) and contour accuracy ( [symbol] ) metrics (ibid) and their mean, “( [symbol] & [symbol] ) m”. The table compares the relative performance of pre-training followed by transfer learning using: random pre-training (and clustering); supervised pre-training; the described system 100, “Odin”, omitting a final feature pyramid network feature extractor; and the described system 100, “Odin^{†}”, retaining a final feature pyramid network feature extractor used during training of the system. The system described herein performs substantially better than supervised pre-training.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method of training a neural network, the method comprising, for a plurality of training data items:
processing the training data item using an object discovery neural network to generate an object segmentation of the training data item, wherein the object segmentation defines a segmentation of the training data item into a plurality of different objects represented by the training data item;
processing a first transformed view of the training data item with a first feature representation neural network to generate a first representation of the first transformed view;
processing a second transformed view of the training data item with a second feature representation neural network to generate a second representation of the second transformed view;
combining the object segmentation and the first representation to generate a first object representation for each of the objects in the first transformed view;
combining the object segmentation and the second representation to generate a second object representation for each of the objects in the second transformed view;
updating parameters of the first feature representation neural network by comparing a predicted object representation dependent upon the first object representation, and the second object representation;
updating parameters of the second feature representation neural network based on the parameters of the first feature representation neural network; and
updating parameters of the object discovery neural network based on the parameters of the first feature representation neural network.

2. The method of claim 1, wherein updating parameters of the first feature representation neural network by comparing the predicted object representation and the second object representation comprises:
determining a value of a contrastive objective function, wherein the contrastive objective function has a first term dependent upon a first measure of similarity between the predicted object representation for one of the objects in the first transformed view and the second object representation for the same object in the second transformed view, and a second term dependent upon a second measure of similarity between the predicted object representation for one of the objects in the first transformed view and the second object representation for a different one of the objects in the second transformed view of the training data item or of another training data item; and wherein
updating parameters of the first feature representation neural network comprises updating the parameters to maximize the first term and to minimize the second term.

3. The method of claim 2, wherein determining the value of the contrastive objective function comprises, for each of the objects that is in both the first transformed view and the second transformed view:
determining the first term of the contrastive objective function by computing the first measure of similarity between the predicted object representation for the object in the first transformed view and the second object representation for the same object in the second transformed view; and
determining the second term of the contrastive objective function by computing the second measure of similarity between the predicted object representation for the object in the first transformed view and the second object representation for each different object in the second transformed view of the training data item.

4. The method of claim 1, wherein the object discovery neural network comprises an object discovery feature representation neural network to process the training data item to generate a feature map of the training data item for generating the object segmentation, wherein the object discovery feature representation neural network has the same architecture as the first feature representation neural network; the method further comprising:
processing the training data item using the object discovery feature representation neural network to generate the feature map of the training data item;
using the feature map of the training data item to generate the object segmentation of the training data item; and
updating the parameters of the object discovery feature representation neural network to approach or equal values of the parameters of the first feature representation neural network.

5. The method of claim 4, wherein the feature map defines, for elements of the training data item, a respective feature vector for the element; and wherein processing the training data item using the object discovery neural network to generate the object segmentation of the training data item comprises grouping similar feature vectors to determine a set of groups of feature vectors and corresponding groups of elements of the training data item, one group for each of the different objects, wherein the groups of the elements of the training data item define the object segmentation.

6. The method of claim 5, wherein each group of elements of the training data item defines a respective mask for the group of elements, and wherein each mask defines elements for a respective one of the different objects.

7. The method of claim 6, wherein the first representation of the first transformed view comprises a first representation feature map; and wherein the second representation of the second transformed view comprises a second representation feature map; the method further comprising:
generating the first object representation for each of the objects in the first transformed view by applying the respective mask for each of the objects in the first transformed view to the first representation feature map; and
generating the second object representation for each of the objects in the second transformed view by applying the respective mask for each of the objects in the second transformed view to the second representation feature map.

8. The method of claim 1 wherein updating parameters of the object discovery neural network based on the parameters of the first feature representation neural network comprises updating parameters of the object discovery neural network with a moving average of the parameters of the first feature representation neural network.

9. The method of claim 1 wherein updating parameters of the object discovery neural network based on the parameters of the first feature representation neural network comprises updating parameters of the object discovery neural network with a copy of the parameters of the first feature representation neural network.

10. The method of claim 1, wherein the method is performed iteratively by:
processing a first training data item using the object discovery neural network to generate the object segmentation of the first training data item;
generating the first object representation and the second object representation from the first training data item using the object segmentation of the first training data item;
updating the parameters of the first feature representation neural network by comparing the predicted object representation and the second object representation from the first training data item;
updating the parameters of the second feature representation neural network;
updating the parameters of the object discovery neural network based on the updated parameters of the first feature representation neural network;
processing a second training data item using the object discovery neural network, after updating the parameters of the object discovery neural network, to generate the object segmentation of the second training data item;
generating the first object representation and the second object representation from the second training data item using the object segmentation of the second training data item;
updating the parameters of the first feature representation neural network by comparing the predicted object representation and the second object representation from the second training data item; and
updating the parameters of the second feature representation neural network.

11. The method of claim 1, wherein the first feature representation neural network and the second feature representation neural network have the same architecture and different parameters, and wherein updating the parameters of the second feature representation neural network comprises updating the parameters to approach values of the parameters of the first feature representation neural network.

12. The method of claim 1, further comprising:
processing the first object representation using a prediction neural network to generate the predicted object representation; and
updating parameters of the prediction neural network by comparing the predicted object representation and the second object representation.

13. The method of claim 1, wherein the predicted object representation is the first object representation.

14. The method of claim 1, wherein
combining the object segmentation and the first representation to generate the first object representation for each of the objects in the first transformed view comprises:
combining the object segmentation and the first representation to generate a first intermediate object representation for each of the objects in the first transformed view, and processing the first intermediate object representation for each of the objects using a first projection neural network to generate the first object representation for each of the objects in the first transformed view;
wherein combining the object segmentation and the second representation to generate the second object representation for each of the objects in the second transformed view comprises:
combining the object segmentation and the second representation to generate a second intermediate object representation for each of the objects in the second transformed view, and processing the second intermediate object representation for each of the objects using a second projection neural network to generate the second object representation for each of the objects in the first transformed view; and further comprising:
updating parameters of the first projection neural network by comparing the predicted object representation and the second object representation; and
updating parameters of the second projection neural network based on the parameters of the first projection neural network.

15. The method of claim 1, further comprising:
generating the first transformed view of the training data item by applying a first data item transformation to the training data item to generate the first transformed view of the training data item; and
generating the second transformed view of the training data item by applying a second data item transformation to the training data item to generate the second transformed view of the training data item,
wherein the second data item transformation is different from the first data item transformation.

16. The method of claim 1 wherein first feature representation neural network and the second feature representation neural network are the same neural network such that updating the parameters of the second feature representation neural network is performed by updating the parameters of the first feature representation neural network.

17. The method of claim 1 wherein the training data item comprises an audio data item, an image data item, a multimodal data item, a text data item, or a graph data item; the method further comprising, after the training, using i) the object discovery neural network, or ii) at least part of the first feature representation neural network or iii) at least part of the second feature representation neural network, correspondingly, to process input data comprising audio data, image data, multimodal data, text data, or graph data respectively to perform an audio signal processing task, an image processing task, a multimodal processing task, a text processing task, or a graph processing task.

18. The method of claim 17, wherein
wherein the audio data comprises data representing values of an audio waveform, and wherein the audio signal processing task comprises: processing audio data representing speech to provide output data that detects words or phonemes in the speech or categorizes words, syllables or phonemes in the speech into one or more of a plurality of categories, or processing audio data representing a sound to provide output data that detects presence of a particular sound or event in the sound, or processing audio data representing a sound to provide output data that categorizes a content of the sound into one or more of a plurality of categories; or
wherein the image data comprises pixels of an image or of video, and wherein the image processing task comprises: processing the image data to provide output data that identifies the location of one or more objects in the image or video, or processing the image data to provide output data that segments pixels of the image or video into regions that represent one or more objects in the image or video signal, or processing the image data to provide output data that categorizes a content of the image or video into one or more of a plurality of categories, or processing the image data to provide output data that predicts depth values for pixels of the image or video; or
wherein the image data comprises pixels of a video and the image processing task comprises: processing the image data to provide output data that identifies the location of one or more actions represented in the video, or processing the image data to provide output data that categorizes one or more actions represented in the video into one or more of a plurality of categories; or
wherein the multimodal data comprises audio-visual data comprising a combination of pixels of an image or of video and audio data representing values of an audio waveform, and wherein the multimodal processing task comprises: processing the combination to provide output data that detects presence of a particular event in the combination, or processing the combination to provide output data that categorizes the combination into one or more of a plurality of categories; or
wherein the multimodal data comprises a combination of text data representing text in a natural language and pixels of an image or of video or audio data representing values of an audio waveform, and wherein the multimodal processing task comprises: processing the combination to provide output data that defines whether the image or video or audio waveform is described by the text.

19-21. (canceled)

22. A system comprising:
one or more computers; and
one or more storage devices communicatively coupled to the one or more computers, wherein the one or more storage devices store instructions that, when executed by the one or more computers, cause the one or more computers to perform operations for training a neural network, the operations comprising, for a plurality of training data items:
processing the training data item using an object discovery neural network to generate an object segmentation of the training data item, wherein the object segmentation defines a segmentation of the training data item into a plurality of different objects represented by the training data item;
processing a first transformed view of the training data item with a first feature representation neural network to generate a first representation of the first transformed view;
processing a second transformed view of the training data item with a second feature representation neural network to generate a second representation of the second transformed view;
combining the object segmentation and the first representation to generate a first object representation for each of the objects in the first transformed view;
combining the object segmentation and the second representation to generate a second object representation for each of the objects in the second transformed view;
updating parameters of the first feature representation neural network by comparing a predicted object representation dependent upon the first object representation, and the second object representation;
updating parameters of the second feature representation neural network based on the parameters of the first feature representation neural network; and
updating parameters of the object discovery neural network based on the parameters of the first feature representation neural network.

23. One or more non-transitory computer storage media storing instructions that when executed by one or more computers cause the one or more computers to perform operations for training a neural network, the operations comprising, for a plurality of training data items:
processing the training data item using an object discovery neural network to generate an object segmentation of the training data item, wherein the object segmentation defines a segmentation of the training data item into a plurality of different objects represented by the training data item;
processing a first transformed view of the training data item with a first feature representation neural network to generate a first representation of the first transformed view;
processing a second transformed view of the training data item with a second feature representation neural network to generate a second representation of the second transformed view;
combining the object segmentation and the first representation to generate a first object representation for each of the objects in the first transformed view;
combining the object segmentation and the second representation to generate a second object representation for each of the objects in the second transformed view;
updating parameters of the first feature representation neural network by comparing a predicted object representation dependent upon the first object representation, and the second object representation;
updating parameters of the second feature representation neural network based on the parameters of the first feature representation neural network; and
updating parameters of the object discovery neural network based on the parameters of the first feature representation neural network.
